(19) United States
(12) Patent Application Publication
(10) Pub. No.: US 2015/0299365 A1
(43) Pub. Date: Oct. 22, 2015

(54) NOVEL METHOD FOR PREPARING HEAT-THICKENING POLYMERS AND NOVEL COMB COPOLYMERS

(71) Applicant: SOCIETE D'EXPLOITATION DE PRODUITS POUR LES INDUSTRIES CHIMIQUES SEPPIC, Paris (FR)

(72) Inventors: Paul MALLO, Le Vesinet (FR); Olivier BRAUN, St Just St Rambert (FR)

(21) Appl. No.: 14/647,455

(22) PCT Filed: Nov. 26, 2013
(86) PCT No.: PCT/FR2013/052855

§ 371 Date: May 27, 2015

(30) Foreign Application Priority Data
Dec. 21, 2012 (FR) 1262528

(51) Int. Cl. C08F 265/10

(52) U.S. Cl. CPC C08F 265/10

(57) ABSTRACT

Method for preparing a comb copolymer, includes sequentially: (a) reacting a compound of formula (II): CH₂═C(R2)—C(═O)—N(R3)(R4) (II), with a chain-limiting compound of formula (IIIa): HS—R1—NH2 (IIIa) or of formula (IIIb): HS—R1—C(═O)—OH (IIIb), to obtain a poly(N-alkyl acrylamide) or poly(N,N-dialkyl acrylamide) telomer, of formula (Ia): H2N—R1—S—{CH2—C(R2)[C(═O)N(R3)(R4)]-}n-H (Ia) or of formula (Ib): HO—C(═O)—R1—S—{CH2—C(R2)[C(⊚O)N(R3)(R4)]-}n-H (Ib) formula (IIIa) or (IIIb) where n represents a whole number ≧2 and ≦100; (b) isolating and/or drying the obtained telomer; (c) reacting the telomer of formula (Ia) or of formula (Ib) in tert-butanol with glycidyl methacrylate (IV) to obtain a solution of the macromonomer of formula (Va): CH2═C(R5)-C(═O)—NH—R1—Z—{CH2—C(R2)[C(═O)N(R3)(R4)]-}n-H (Va) or of formula (Vb); CH2═C(R5)-C(═O)—O—(C═O)-R1—Z—{CH2—C(R2)[C(═O)N(R3) (R4)]-}n-H (Vb); (d) isolating and/or drying the obtained telomer; (e) copolymerizing the macromonomer of formula (Va) or of formula (Vb) in tert-butanol with the ammonium salt of 2-acrylamido-2-methyl-propanesulphonic acid, and, if applicable, with the optional monomer or monomers in the desired molar proportions.

The present patent application has as subject matter a novel process for the preparation of water-soluble grafted copolymers.

Heat-thickening polymers are polymers, the viscosity of which varies considerably as a function of the temperature. The are characterized in particular by a “critical” temperature, above which the viscosity of their aqueous solution very markedly increases, generally by a factor of several tens.

International application WO 00/40958 describes a process for the preparation of copolymers of acrylamide and of poly(N-isopropylacrylamide) which includes the following successive stages:

(a) the synthesis of an N-isopropylacrylamide (NIPAM) telomer by radical polymerization;

(b) the isolation of the telomer obtained, (PNIPAM)ₓ-NH₂, by precipitation from ether, filtration and then drying;

(c) the reaction in methylene chloride of (PNIPAM)ₓ-NH₂ with a large excess of acrylic acid in the presence of cyclohexylcarbodiimide to result in the poly(NIPAM) macromonomer carrying an acryloyl functional group at the (PNIPAM)ₓ chain end;

(d) the isolation of the macromonomer obtained by precipitation from ether, filtration and then drying;

(e) the copolymerization of the macromonomer obtained with acrylamide (AM) or dimethylacrylamide (DMA) in water, in order to obtain the grafted copolymers comprising a (PNIPAM)ₓ segment, AM-g-(PNIPAM)ₓ or DMA-g-(PNIPAM)ₓ;

(f) the purification by precipitation from water for DMA/(PNIPAM)ₓ or from acetone for AM/(PNIPAM)ₓ, followed by ultrafiltration.

The international application published under the number WO 2007/000535 discloses a process for the preparation of grafted polymers, while limiting as much as can be done the use of organic solvents, and more particularly a process for the preparation of a comb copolymer, the backbone of which is of the acrylamide, acrylic acid, acryloylaminoethanol or dimethylacrylamide type, to which poly(N-alkylacrylamide) or poly(N,N-dialkylacrylamide) side segments are grafted, comprising the following successive stages:

(a) the preparation of a poly(N-alkylacrylamide) or poly(N,N-dialkylacrylamide) telomer, of formula (I):

H₂N—R₁—Z—{CH₂—C(R₂)[C(═O)N(R₃)(R₄)]-}ₙ-H (I)
in which n represents an integer greater than or equal to 2 and less than or equal to 100, Z represents a functional group capable of acting as radical transfer agent, R₁ represents a divalent radical comprising from 1 to 4 carbon atoms, R₂ represents a hydrogen atom or a methyl radical, R₃ represents a hydrogen atom or a linear or branched alkyl radical comprising from 1 to 4 carbon atoms and R₄, which is identical to or different from R₃, represents a linear or branched alkyl radical comprising from 1 to 4 carbon atoms, by reaction in water of a compound of formula (II):

CH₂═C(R₂)—C(═O)N(R₃)(R₄) (II)
in which R₂, R₃ and R₄ are as defined above, with a chain-limiting compound of formula (III):

Z—R₁—NH₂ (II)
in which Z represents a functional group capable of acting as radical transfer agent, in a (II)/(III) molar ratio of less than or equal to n and greater than or equal to n/10, in the presence of a polymerization initiator;

(b) the isolation of the telomer of formula (I) obtained in stage (a);

(c) the reaction in water of the telomer of formula (I) obtained in stage (b) with the acid chloride of formula (IV):

CH₂═C(R₅)—C(═O)—Cl (IV)
in which R₅ represents a hydrogen atom or a methyl radical and in a (IV)/(III) molar ratio of less than or equal to 10 and greater than or equal to 1, while maintaining the pH of the reaction medium at a value of between 6 and 13 and preferably between 7 and 8, in order to obtain a macromonomer of formula (V):

CH₂═C(R₅)—C(═O)NH—R₁—Z—{CH₂—C(R₂)[C(═O)N(R₃)(R₄)]}-ₙ-H (V);

(d) the isolation of the macromonomer of formula (V) obtained in stage (c);

(e) the copolymerization in water of the macromonomer of formula (V) isolated in stage (d) with a monomer chosen from acrylamide, acrylic acid, acryloylaminoethanol or dimethylacrylamide and, if desired;

(f) the purification of the comb copolymer obtained.

In point of fact, while the process thus disclosed operates perfectly when the main backbone is composed of a sequence of neutral monomers, it is not the same when it is desired to replace these neutral monomers with ionic monomers, such as acrylic acid or 2-acrylamido-2-methylpropanesulfonic acid (ATBS). This is because a salting out phenomenon occurs, which results in the polymerization of the macromonomer intended to form the pendant chains, such as the poly(N-isopropylacrylamide) macromonomer.

The French patent application filed on 15 Jun. 2012 and registered under the number 12 55617 discloses a process for the preparation of a comb copolymer, the backbone of which is of the 2-acrylamido-2-methylpropanesulfonic acid (ATBS) type, to which poly(N-alkylacrylamide) or poly(N,N-dialkylacrylamide) side segments are grafted, comprising the following successive stages:

a stage (a) of reaction of a compound of formula (II):

CH₂═C(R₂)—C(═O)—N(R₃)(R₄) (II)
in which R₂ represents a hydrogen atom or a methyl group, R₃ represents a hydrogen atom or a linear or branched alkyl radical comprising from 1 to 4 carbon atoms and R₄, which is identical to or different from R₃, represents a linear or branched alkyl radical comprising from 1 to 4 carbon atoms, with a chain-limiting compound of formula (III):

Z—R₁—NH₂ (III)
in which R₁ represents a divalent radical comprising from 1 to 4 carbon atoms and Z represents a functional group capable of acting as radical transfer agent, in the presence of a polymerization initiator, in a tert-butanol/water mixture, in order to obtain a poly(N-alkylacrylamide) or poly(N,N-dialkylacrylamide) telomer of formula (I):

H₂N—R₁—Z—{CH₂—C(R₂)[C(═O)N(R₃)(R₄)]-}₄-H (I)
in which n represents an integer greater than or equal to 2 and less than or equal to 100 and Z represents a functional group capable of acting as radical transfer agent; optionally

a stage (b) of isolation and/or of drying of said telomer of formula (I) obtained in stage (a);

a stage (c) of reaction in tert-butanol of the telomer of formula (I) obtained in stage (a) or optionally in stage (b) with an acid chloride of formula (IV):

CH₂═C(R₅)-C(═O)—Cl (IV)
in which R₅ represents a hydrogen atom or a methyl radical, in a (IV)/(III) molar ratio of less than or equal to 10 and greater than or equal to 1, while maintaining the pH of the reaction medium at a value of between 8 and 10, in order to obtain a solution of the macromonomer of formula (V):

CH₂═C(R₅)—C(═O)NH—R₁—Z—{CH₂—C(R₂)[C(═O)N(R₃)(R₄)]-}₄-H (V);
optionally

a stage (d) of isolation and/or of drying of said telomer of formula (I) obtained in stage (c);

a stage (e) of copolymerization in tert-butanol of the macromonomer of formula (V) resulting from stage (c) or from stage (d) with the ammonium salt of 2-acrylamido-2-methylpropanesulfonic acid and, if desired, of other monomers.

However, this process exhibits the disadvantage of employing an acid chloride, acryloyl chloride, the industrial use of which is problematic and requires the use and the monitoring of highly restrictive procedures in order to ensure optimum safety.

For this reason, the inventors have attempted to develop a process which does not exhibit this disadvantage.

A subject matter of the invention is thus a process for the preparation of a comb copolymer, the backbone of which is composed, for 100 mol %:

of 50 mol % to 100 mol % and more particularly of 75 mol % to 100 mol % of monomer units resulting from 2-acrylamido-2-methylpropanesulfonic acid (ATBS) which is free, partially salified or completely salified in the ammonium salt form,

optionally of up to 50 mol % in the ammonium salt form and more particularly up to 25 mol % of monomer units resulting from at least one monomer chosen from acrylamide, 2-hydroxyethyl acrylate, N,N-dimethylacrylamide or acrylic acid partially or completely salified in the ammonium salt form, and

optionally of 0.005 mol % to 1 mol %, more particularly of 0.01 mol % to 0.5 mol %, of monomer units resulting from at least one crosslinking monomer comprising at least two carbon-carbon double bonds,

to which backbone poly(N-alkylacrylamide) or poly(N,N-dialkylacrylamide) side segments are grafted, said process comprising the following successive stages:

a stage (a) of reaction of a compound of formula (II):

CH₂═C(R₂)—C(═O)—N(R₃)(R₄) (II)
in which R₂ represents a hydrogen atom or a methyl group, R₃ represents a hydrogen atom or a linear or branched alkyl radical comprising from 1 to 4 carbon atoms and R₄, which is identical to or different from R₃, represents a linear or branched alkyl radical comprising from 1 to 4 carbon atoms, with a chain-limiting compound of formula (IIIa):

HS—R₁—NH₂ (IIIa)
or of formula (IIIb):

HS—R₁—C(═O)—OH (IIIb)
in which formula (IIIa) or (IIIb) R₁ represents a divalent radical comprising from 1 to 4 carbon atoms, in the presence of a polymerization initiator, in a tert-butanol/water mixture, in order to obtain a poly(N-alkylacrylamide) or poly(N,N-dialkylacrylamide) telomer of formula (Ia):

H₂N—R₁—S—{CH₂—C(R₂)[C(═O)N(R₃)(R₄)]-}ₙ-H (Ia)
or of formula (Ib):

HO—C(═O)—R₁—S—{CH₂—C(R₂)[C(═O)N(R₃)(R₄)]-}₄-H (Ib)
in which formula (IIIa) or (IIIb) n represents an integer of greater than or equal to 2 and less than or equal to 100; optionally

a stage (b) of isolation and/or drying of said telomer of formula (Ia) or of formula (Ib) obtained in stage (a);

a stage (c) of reaction in tert-butanol of the telomer of formula (Ia) or of formula (Ib) obtained in stage (a), or optionally in stage (b), with glycidyl methacrylate (IV) and in a (IV)/(IIIa) or (IV)/(IIIb) molar ratio of less than or equal to 10 and greater than or equal to 1, while maintaining the pH of the reaction medium at a value of greater than 10 and less than or equal to 13, more particularly of greater than or equal to 11 and less than or equal to 12, in order to obtain, after adjustment of the pH to a value of greater than or equal to 7 and less than or equal to 9, preferably less than or equal to 8, a solution of the macromonomer of formula (Va):

CH₂═C(R₅)—C(═O)—NH—R₁—Z—{CH₂—C(R₃)(R₄)]-}ₙ-H (Va)
or of formula (Vb):

CH₂═C(R₅)—C(═O)—O—(C═O)—R₁—Z—{CH₂—C(R₂)[C(═O)N(R₃)(R₄)]-}₄-H (Vb);
optionally

a stage (d) of isolation and/or drying of said macromonomer of formula (Va) or of formula (Vb) obtained in stage (c);

a stage (e) of copolymerization in tert-butanol of the macromonomer of formula (Va) or of formula (Vb) resulting from stage (c) or from stage (d) with the ammonium salt of 2-acrylamido-2-methylpropanesulfonic acid and, if appropriate, with the optional monomer or monomers and/or the crosslinking monomer or monomers comprising at least two carbon-carbon double bonds in the desired molar proportions, and, if desired;

a stage (f) of purification of the comb copolymer obtained in stage (e).

The glycidyl methacrylate, or [(oxiranyl)methyl] methacrylate, employed in stage (c) of the process as defined above is identified in Chemical Abstracts under the number RN=106-91-2.

The crosslinking monomers comprising at least two carbon-carbon double bonds which can be employed in stage (e) of the process as defined above include, for example, ethylene glycol dimethacrylate, tetraallyloxyethane, ethylene glycol diacrylate, diallylurea, triallylamine, trimethylolpropane triacrylate or methylenebis(acrylamide), or a mixture of these compounds.

According to a specific aspect of the process as defined above, in stage (e) as described above, the crosslinking agent is more particularly employed in a molar proportion of greater than or equal to 0.01% and less than or equal to 0.25%.

Another subject matter of the invention is more particularly the process as defined above in which the poly(N-alkyl(meth)acrylamide) or poly(N,N-dialkyl(meth)acrylamide) side segments are chosen from the following side segments:

poly(N-methylmethacrylamide) side segments,

poly(N-ethylmethacrylamide) side segments,

poly(N-propylmethacrylamide) side segments,

poly(N-isopropylmethacrylamide) side segments,

poly[N-(2-hydroxyethyl)methacrylamide] side segments,

poly(N,N-dimethylmethacrylamide) side segments,

poly(N,N-diethylmethacrylamide) side segments,

poly(N-methylacrylamide) side segments,

poly(N-ethylacrylamide) side segments,

poly(N-propylacrylamide) side segments,

poly(N-isopropylacrylamide) side segments,

poly[N-(2-hydroxyethyl)acrylamide] side segments,

poly(N,N-dimethylacrylamide) side segments,

poly(N,N-diethylacrylamide) side segments,
and more particularly a comb copolymer as defined above in which said side segments are chosen from the following side segments:

poly(N-isopropylacrylamide) side segments,

poly[N-(2-hydroxyethyl)acrylamide] side segments,

poly(N,N-dimethylacrylamide) side segments and

poly(N,N-diethylacrylamide) side segments.

According to a final aspect, a subject matter of the invention is a comb copolymer, the backbone of which is composed, for 100 mol %:

of 50 mol % up to less than 100 mol % and more particularly of 75 mol % to less than 100 mol % of monomer units resulting from 2-acrylamido-2-methylpropanesulfonic acid (ATBS) which is free, partially salified or completely salified in the ammonium salt form,

of up to 50 mol % in the ammonium salt form and more particularly up to 25 mol % of monomer units resulting from at least one monomer chosen from acrylamide, 2-hydroxyethyl acrylate, N,N-dimethylacrylamide or acrylic acid partially or completely salified in the ammonium salt form, and

optionally of 0.005 mol % to 1 mol %, more particularly of 0.01 mol % to 0.5 mol %, of monomer units resulting from at least one crosslinking monomer comprising at least two carbon-carbon double bonds,

to which backbone poly(N-alkylacrylamide) or poly(N,N-dialkylacrylamide) side segments are grafted, and more particularly a comb copolymer as defined above in which the side segments are chosen from:

poly(N-methylmethacrylamide) side segments,

poly(N-ethylmethacrylamide) side segments,

poly(N-propylmethacrylamide) side segments,

poly(N-isopropylmethacrylamide) side segments,

poly[N-(2-hydroxyethyl)methacrylamide] side segments,

poly(N,N-dimethylmethacrylamide) side segments,

poly(N,N-diethylmethacrylamide) side segments,

poly(N-methylacrylamide) side segments,

poly(N-ethylacrylamide) side segments,

poly(N-propylacrylamide) side segments,

poly(N-isopropylacrylamide) side segments,

poly[N-(2-hydroxyethyl)acrylamide] side segments,

poly(N,N-dimethylacrylamide) side segments,

poly(N,N-diethylacrylamide) side segments,
and more particularly a comb copolymer as defined above in which said side segments are chosen from the following side segments:

poly(N-isopropylacrylamide) side segments,

poly[N-(2-hydroxyethyl)acrylamide] side segments,

poly(N,N-dimethylacrylamide) side segments and

poly(N,N-diethylacrylamide) side segments.

The following example illustrates the invention without, however, limiting it. It demonstrates that it is possible to prepare comb polymers without an acrylamide backbone comprising side segments of N-alkylacrylamide type which are heat-thickening.

### Preparation of a Comb Copolymer Comprising a Backbone of the ATBS Type, to Which Poly(N-Isopropylacrylamide) Side Segments are Grafted ATBS-q-NIPAM

(1) Preparation of a Poly(N-Isopropylacrylamide) Telomer

60 g of N-isopropylacrylamide (NIPAM) are dissolved at 25° C. in 75 g of a tert-butanol/water (50/50 by volume) mixture in a thermostatically controlled reactor, which is stirred for approximately 1 hour while sparging with nitrogen. 0.9 g of 2-aminoethanethiol hydrochloride (AET.HCl) is subsequently added. The polymerization is initiated by adding 1.33 g of dilauroyl peroxide, the temperature being brought to 60° C., and then the reaction medium is left stirring for a further three and a half hours while sparging with nitrogen. 87 g of tert-butanol are subsequently added to result in a white and pasty final reaction mixture.

(2) Preparation of the Macromonomer

0.5 g of a 48% by weight solution of sodium hydroxide in tert-butanol is added to the reaction medium obtained in stage (1) maintained at a temperature of 10° C., in order to bring the pH to approximately 12 during. 3.16 g of glycidyl methacrylate are then added and the reaction is left to take place for one hour. At the end of the reaction, approximately 1.3 g of 15% hydrochloric acid in water are added in order to lower the pH to a value of between 7 and 8. The solution obtained comprises 28.1% by weight of NIPAM macromonomer and 17% by weight of water.

(3) Synthesis of the Copolymer

40.5 g of the solution obtained in stage 2 are diluted in 487.5 g of tert-butanol in the reactor thermostatically controlled at 25° C.; 75.2 g of 2-acrylamido-2-methylpropanesulfonic acid powder are added thereto and then 5.5 g of ammonia are injected into the reaction mixture, so as to obtain a pH approximately equal to 6. 0.5 g of water and 0.48 g of trimethylolpropane triacrylate (TMPTA) are then added. After sparging with nitrogen for 1 h and heating to 60° C., the polymerization is initiated with 1 g of dilauroyl peroxide. After reacting for 3 h, the product is emptied, filtered and dried. The desired copolymer is obtained in the form of a white powder.
Viscosity of a 1% solution of the comb copolymer in water at 25° C.: p0 μ=10 000 mPa·s (Brookfield RVT Spindle 4; Rate: 5 revolutions/minute)
Viscosity of a 1% solution of the comb copolymer in water at 50° C.: p0 μ=50 000 mPa·s (Brookfield RVT Spindle 5; Rate: 5 revolutions/minute)
This difference in viscosity observed between 25° C. and 50° C. is characteristic of a heat-thickening polymer.

1. A process for the preparation of a comb copolymer, the backbone of which is composed, for 100 mol %:
of 50 mol % to 100 mol % and more particularly of 75 mol % to 100 mol % of monomer units resulting from 2-acrylamido-2-methylpropanesulfonic acid (ATBS) which is free, partially salified or completely salified,
optionally of up to 50 mol % in the ammonium salt form and more particularly up to 25 mol % of monomer units resulting from at least one monomer chosen from acrylamide, 2-hydroxyethyl acrylate, N,N-dimethylacrylamide or acrylic acid partially or completely salified in the ammonium salt form, and
optionally of 0.005 mol % to 1 mol %, more particularly of 0.01 mol % to 0.5 mol %, of monomer units resulting from at least one crosslinking monomer comprising at least two carbon-carbon double bonds,
to which backbone poly(N-alkylacrylamide) or poly(N,N-dialkylacrylamide) side segments are grafted, said process comprising the following successive stages:
a stage (a) of reaction of a compound of formula (II):
CH₂═C(R₂)—C(═O)—N(R₃)(R₄) (II)
in which R₂ represents a hydrogen atom or a methyl group, R₃ represents a hydrogen atom or a linear or branched alkyl radical comprising from 1 to 4 carbon atoms and R₄, which is identical to or different from R₃, represents a linear or branched alkyl radical comprising from 1 to 4 carbon atoms, with a chain-limiting compound of formula (IIIa):
HS—R₁—NH₂ (IIIa)
or of formula (IIIb):
HS—R₁—C(⊚O)—OH (IIIb)
in which formula (IIIa) or (IIIb) R₁ represents a divalent radical comprising from 1 to 4 carbon atoms, in the presence of a polymerization initiator, in a tert-butanol/water mixture, in order to obtain a poly(N-alkylacrylamide) or poly(N,N-dialkylacrylamide) telomer of formula (Ia):
H₂N—R₁—S—{CH₂—C(R₂)[C(═O)N(R₃)(R₄)]-}₄-H (Ia)
or of formula (Ib):
HO—C(═O)—R₁—S—{CH₂—C(R₂)[C(═O)N(R₃)(R₄)]-}₄-H (Ib)
in which formula (IIIa) or (IIIb) n represents an integer of greater than or equal to 2 and less than or equal to 100; optionally
a stage (b) of isolation and/or drying of said telomer of formula (Ia) or of formula (Ib) obtained in stage (a);
a stage (c) of reaction in tert-butanol of the telomer of formula (Ia) or of formula (Ib) obtained in stage (a), or optionally in stage (b), with glycidyl methacrylate (IV) and in a (IV)/(IIIa) or (IV)/(IIIb) molar ratio of less than or equal to 10 and greater than or equal to 1, while maintaining the pH of the reaction medium at a value of greater than 10 and less than or equal to 13, more particularly of greater than or equal to 11 and less than or equal to 12, in order to obtain, after adjustment of the pH to a value of greater than or equal to 7 and less than or equal to 9, preferably less than or equal to 8, a solution of the macromonomer of formula (Va):
CH₂═C(R₅)—C(═O)—NH—R₁—Z—{CH₂—C(R₂)[C(═O)N(R₃)(R₄)]-}₄-H (Va)
or of formula (Vb):
CH₂═C(R₅)—C(═O)—O—(C═O)—R₁—Z—{CH₂—C(R₂)[C(═O)N(R₃)(R₄)]-}₄-H (Vb);
optionally
a stage (d) of isolation and/or drying of said macromonomer of formula (Va) or of formula (Vb) obtained in stage (c);
a stage (e) of copolymerization in tert-butanol of the macromonomer of formula (Va) or of formula (Vb) resulting from stage (c) or from stage (d) with the ammonium salt of 2-acrylamido-2-methylpropanesulfonic acid and, if appropriate, with the optional monomer or monomers and/or the crosslinking monomer or monomers comprising at least two carbon-carbon double bonds in the desired molar proportions, and, if desired;
a stage (f) of purification of the comb copolymer obtained in stage (e).

2. The process as defined in claim 1, in which the poly(N-alkyl(meth)acrylamide) or poly(N,N-dialkyl(meth)acrylamide) side segments are chosen from the following side segments:
poly(N-methylmethacrylamide) side segments,
poly(N-ethylmethacrylamide) side segments,
poly(N-propylmethacrylamide) side segments,
poly(N-isopropylmethacrylamide) side segments,
poly[N-(2-hydroxyethyl)methacrylamide] side segments,
poly(N,N-dimethylmethacrylamide) side segments,
poly(N,N-diethylmethacrylamide) side segments,
poly(N-methylacrylamide) side segments,
poly(N-ethylacrylamide) side segments,
poly(N-propylacrylamide) side segments,
poly(N-isopropylacrylamide) side segments,
poly[N-(2-hydroxyethyl)acrylamide] side segments,
poly(N,N-dimethylacrylamide) side segments,
poly(N,N-diethylacrylamide) side segments.

3. The process as defined in claim 2, in which the side segments are chosen from the following side segments:
poly(N-isopropylacrylamide) side segments,
poly[N-(2-hydroxyethyl)acrylamide] side segments,
poly(N,N-dimethylacrylamide) side segments and
poly(N,N-diethylacrylamide) side segments.

4. A comb copolymer, the backbone of which is composed, for 100 mol %:
of 50 mol % up to less than 100 mol % and more particularly of 75 mol % to less than 100 mol % of monomer units resulting from 2-acrylamido-2-methylpropanesulfonic acid which is free, partially salified or completely salified in the ammonium salt form,
of up to 50 mol % in the ammonium salt form and more particularly up to 25 mol % of monomer units resulting from at least one monomer chosen from acrylamide, 2-hydroxyethyl acrylate, N,N-dimethylacrylamide or acrylic acid partially or completely salified in the ammonium salt form, and
optionally of 0.005 mol % to 1 mol %, more particularly of 0.01 mol % to 0.5 mol %, of monomer units resulting from at least one crosslinking monomer comprising at least two carbon-carbon double bonds,
to which backbone poly(N-alkylacrylamide) or poly(N,N-dialkylacrylamide) side segments are grafted.

5. The comb copolymer as defined in claim 4, in which the side segments are chosen from:
poly(N-methylmethacrylamide) side segments,
poly(N-ethylmethacrylamide) side segments,
poly(N-propylmethacrylamide) side segments,
poly(N-isopropylmethacrylamide) side segments,
poly[N-(2-hydroxyethyl)methacrylamide] side segments,
poly(N,N-dimethylmethacrylamide) side segments,
poly(N,N-diethylmethacrylamide) side segments,
poly(N-methylacrylamide) side segments,
poly(N-ethylacrylamide) side segments,
poly(N-propylacrylamide) side segments,
poly(N-isopropylacrylamide) side segments,
poly[N-(2-hydroxyethyl)acrylamide] side segments,
poly(N,N-dimethylacrylamide) side segments,
poly(N,N-diethylacrylamide) side segments.

6. The comb copolymer as defined in claim 5, in which said side segments are chosen from the following side segments:
poly(N-isopropylacrylamide) side segments,
poly[N-(2-hydroxyethyl)acrylamide] side segments,
poly(N,N-dimethylacrylamide) side segments and
poly(N,N-diethylacrylamide) side segments.
